(19) United States
(12) Patent Application Publication
(10) Pub. No.: US 2021/0160050 A1
(43) Pub. Date: May 27, 2021

(54) METHOD FOR ESTABLISHING ANONYMOUS DIGITAL IDENTITY

(71) Applicant: Korea Smart Authentication Corp., Seoul (KR)

(72) Inventors: Kibong MOON, Seoul (KR); Joonkoo KANG, Seoul (KR); Hawon HAN, Seoul (KR)

(21) Appl. No.: 17/167,835

(22) Filed: Feb. 4, 2021

Related U.S. Application Data
(63) Continuation of application No. PCT/KR2019/005821, filed on May 15, 2019.

(30) Foreign Application Priority Data
Aug. 7, 2018 (KR) 10-2018-0091692

(51) Int. Cl. H04L 9/00; H04L 29/06; G06F 21/62

(52) U.S. Cl. CPC H04L 9/008; G06F 21/6254; H04L 63/0876

(57) ABSTRACT

The present disclosure relates to a method of establishing a digital identity that reserve a privacy of an entity. The method comprises a first step of receiving a validity verification value and verifying the value; a second step of a homomorphic encryption value of a tag based on a homomorphic encryption value of a identity verification ID; and a third step of associating an anonymous digital identity with identity verification information and storing them if a value which is calculated by carrying out a predetermined arithmetic operation to the homomorphic encryption value is identical to the tag.

### CROSS-REFERENCE TO RELATED APPLICATIONS

This application is a Continuation of International Application No. PCT/KR2019/005821, filed on May 15, 2019, which claims priority to Korean Application No. 10-2018-0091692, filed on Aug. 7, 2018. Both applications are incorporated herein by reference in their entirety.

### TECHNICAL FILED

The present disclosure relates to a method for establishing an anonymous digital identity which protects privacy of a user.

### BACKGROUND

There has been a need of digital identity which proves a user's identity in a virtual space such as online environment as services in the virtual space increase.

The digital identity is connected to a personal information of a user. Thus, a privacy problem can be raised when traces of using digital services are leaked. In particular, the digital identity is more vulnerable to copying, manipulation and the theft because it can be unlimitedly reproduced and it is difficult to discriminate between the original and the reproduced one.

In order to prevent an unauthorized copy and maintain the value of digital contents, a third party should keep the digital contents within its server and restrict access to the digital contents. However, the method is not reliable because the server can be hacked and the information can be leaked from the third party.

The problems such as hacking, unauthorized copy and need of the third party can be resolved if the digital contents (hereinafter, referred to as “digital identity”) is stored in a block chain. However, the privacy can be more threatened because the block chain is operated under the condition that any one can access the information in the block chain.

### SUMMARY

The object of the present disclosure is to provide a method for establishing a digital identity wherein the digital identity is connected to an existence of a specific person in a real world; but the attribute of the person is used for just associating the existence in the real world with the digital identity or verifying a predetermined credentials such as minor/adult status and nationality without constituting the digital identity, thereby guaranteeing anonymity.

A computer-implemented method of establishing a digital identity of the present disclosure is carried out in an environment including a user terminal, an account module and a repository. The method comprises a first step of receiving, by the repository, an identity verification information, a second homomorphic encryption value which is a value calculated by carrying out homomorphic encryption to a second identity verification ID, a third validity verification value which is a value generated by carrying out electronic signature to the second homomorphic encryption value, from the user terminal; a second step of verifying, by the repository, the third validity verification value; a third step of verifying, by the repository, querying the identity verification information; a fourth step of generating, by the repository, a third homomorphic encryption value which is a value generated by carrying out homomorphic encryption to the third identity verification ID; a fifth step of generating, by the repository, a value which is calculated by carrying out a first arithmetic operation to a first random value, the third homomorphic encryption value and a second random value, as a fourth homomorphic encryption value which is a value calculated by carrying out homomorphic encryption to a tag; a sixth step of transmitting, by the repository, a session ID, the third homomorphic encryption value and the fourth homomorphic encryption value, to the user terminal; a seventh step of receiving, by the repository, the session ID, the third identity verification ID and the tag from the user terminal; and an eighth step of storing, by the repository, the third identity verification ID and the identity verification information if the value calculated by carrying out the first arithmetic operation to the first random value, the third homomorphic encryption value and the second random value is identical to the tag received in the seventh step.

The first identity verification ID is uniquely assigned to the account module for each user; the second identity verification ID is calculated by carrying out one-way function to a value including the first identity verification ID; and the third identity verification ID is calculated by carrying out one-way function to a value including the second homomorphic encryption value.

The method of establishing the digital identity of the present disclosure further comprises a 1-1 step of receiving, by the repository, the identity verification information from the user terminal; a 1-2 step of determining, by the repository, whether the received identity verification information is the information which is previously stored; a 1-3 step of generating a first validity verification value by carrying out electronic signature to a first value, by the repository, when it is determined that the identity verification information is not previously stored; a 1-4 step of transmitting, by the repository, the first value and the first validity verification value to the user terminal; a 1-5 step of receiving, by the account module, a first homomorphic encryption value which is a value calculated by carrying out homomorphic encryption to a 2-1 value generated by the user terminal, the first value, and the first validity verification value, from the user terminal; a 1-6 step of generating, by the account module, a first identity verification ID; a 1-7 step of storing, by the account module, the first identity verification ID and the first homomorphic encryption value; a 1-8 step of generating, by the account module, a second validity verification value which verifies the first identity verification ID; a 1-9 step of generating, by the account module, the second identity verification ID; a 1-10 step of generating, by the account module, the second homomorphic encryption value by homomorphically-encryption the second identity verification ID; a 1-11 step of generating, by the account module, a third validity verification value by carrying out electronic signature to a third value including the second homomorphic encryption value; and a 1-12 step of transmitting, by the account module, the first identity verification ID, the second validity verification value, the third value, and the third validity verification value to the user terminal. The 1-1 step to the 1-12 step are carried out before the first step.

The second identity verification ID can be calculated by operating one-way function to the first identity verification ID, the 2-1 random value generated by the user terminal, and the 2-2 random value generated by the account module.

The third homomorphic encryption value can be calculated by operating one-way function to the second homomorphic encryption value and ID of the repository.

The first value can include the nonce and time information of the repository.

The third value can further include time information of the account module.

The first arithmetic operation can comprise at least the arithmetic operation as follows:

[(one of the third homomorphic encryption value and the third identity verification ID) ×(one of the first random value and the second random value)]±(the other of the first random value and the second random value).

The identity verification information can comprise identity certificate information or biometric information.

A computer-implemented method of verifying identity after the digital identity is established according to the present disclosure comprises a 2-1 step of receiving, by the account module, the first identity verification ID and the second validity verification value, from the user terminal; a 2-2 step of generating, by the account module, a first hash value which is a value calculated by hashing the first identity verification ID and the second validity verification value; a 2-3 step of generating, by the account module, the second homomorphic encryption value which is a value calculated by carrying out homomorphic encryption to the second identity verification ID; a 2-4 step of generating, by the account module, a fifth validity verification value which is a value generated by carrying out electronic signature to a fourth value including the second homomorphic encryption value and the first hash value; a 2-5 step of transmitting, by the account module, the fourth value and the fifth validity verification value; a 2-6 step of receiving, by the repository, the third identity verification ID, the fourth validity verification value, the fourth value, and the fifth validity verification value, from the user terminal; a fifth step of generating, by the repository, the fourth homomorphic encryption value which is a value calculated by homomorphically-encrypting the tag, by carrying out the first arithmetic operation to the third homomorphic encryption value, the first random value, and the second random value; a 2-8 step of transmitting, by the repository, a session ID, the third homomorphic encryption valuer, and the fourth homomorphic encryption value, to the user terminal; a 2-9 step of receiving, by the repository, the session ID, the third identity verification ID, the second validity verification value, and the tag, from the user terminal; a 2-10 step of verifying, by the repository, the tag by determining whether the value calculated by carrying out the first arithmetic operation to the first random value, the third identity verification ID and the second random value is identical to the tag received in the seventh step after the third identity verification ID is verified; a 2-11 step of generating, by the repository, a sixth validity verification value which is a value calculated by carrying out electronic signature to a fifth value including the fifth validity verification value; a 2-12 step of transmitting, by the repository, the fourth value, the fifth validity verification value, and the sixth validity verification value, to the user terminal; a 2-13 step of receiving, by the account module, the first identity verification ID, the second validity verification value, the fourth value, the fifth value, the fifth validity verification value, the sixth validity verification value from the user terminal; a 2-14 step of verifying, by the account module, the fifth validity verification value and the sixth validity verification value; a 2-15 step of verifying, by the account module, the first identity verification ID, the second validity verification value and the first hash value; and a 2-16 step of generating, by the account module, a token, thereafter transmitting the token to the user terminal.

The fourth value can include time information of the account module; and the fifth value can comprise the fifth validity verification value and time information of the repository.

A computer-implemented method of registering an account module of the present disclosure comprises a first step of receiving, by the account module, a request for registering the account module along with a first homomorphic encryption value which is a value calculated by carrying out homomorphic encryption to a 2-1 random value generated by the user terminal, from the user terminal; a second step of generating, by the account module, a first identity verification ID; a third step of storing, by the account module, the first identity verification ID and the first homomorphic encryption value; a fourth step of generating, by the account module, a second validity verification value which verifies the first identity verification ID; a fifth step of generating, by the account module, a second identity verification ID; a sixth step of generating, by the account module, a second homomorphic encryption value which is a value calculated by carrying homomorphic encryption to the second identity verification ID; a seventh step of generating, by the account module, a third validity verification value which is a value calculated by carrying our electronic signature to a third value including the second identity verification ID and the second homomorphic encryption value; and an eighth step of transmitting, by the account module, the first identity verification ID, the second validity verification value, the third value, and the third validity verification value to the user terminal.

According to the present disclosure, a digital identity can be established by registering the repository after the account module is registered as described in the above. The method comprises a 1-1 step of receiving, by the repository, identity verification information, a second homomorphic encryption value which is a value calculated by carrying out homomorphic encryption to the second identity verification ID, and a third validity verification value which is a value calculated by carrying out electronic signature to the second homomorphic encryption value, from the user terminal; a 2-1 step of verifying, by the repository, the third validity verification value; a 3-2 step of querying, by the repository, the identity verification information; a 4-1 step of generating, by the repository, a third homomorphic encryption value which is a value calculated by carrying out homomorphic encryption to the third identity verification ID; a 5-1 step of generating, by the repository, a value by carrying out the first arithmetic operation to the first random value, the third homomorphic encryption value and the second random value, as a fourth homomorphic encryption value which is a value calculated by carrying out homomorphic encryption to the tag; a 6-1 step of transmitting, by the repository, a session ID, the third homomorphic encryption value and the fourth homomorphic encryption value, to the user terminal; a 7-1 step of receiving, by the repository, the session ID, the third identity verification ID and the tag; an 8-1 step of storing, by the repository, the third identity verification ID and the identity verification information, if the value calculated by carrying out the first arithmetic operation to the first random value, the third identity verification ID and the second random value is identical to the tag received in the 7-1 step; a 9-1 step of generating, by the repository, a fourth validity verification value which verifies the third identity verification ID; a 10-1 step of generating, by the repository, a ninth validity verification value which is a value calculated by carrying out electronic signature to a value including a third value and the third validity verification value; a 11-1 step of transmitting, by the repository, the fourth verification value and the ninth validity verification value, to the user terminal; a 12-1 step of receiving, by the account module, a request of registering the repository along with the first identity verification ID, the third value, the third validity verification value and the ninth validity verification value, from the user terminal; and a 13-1 step of registering, by the account module, the repository if the third validity verification value and the ninth validity verification value are verified.

A computer-implemented method of establishing a digital identity according to another aspect of the present disclosure comprises a first step of receiving, by the repository, identity verification information, a second homomorphic encryption value which is a value calculated by carrying out homomorphic encryption to a second identity verification ID, a third verification value which is a value calculated by carrying out electronic signature to the second homomorphic encryption value, and an encryption value (Ze) of zero from the user terminal; a second step of verifying, by the repository, the third validity verification value; a third step of querying, by the repository, the identity verification information; a fourth step of generating, by the repository, a third homomorphic encryption value which is a value calculated by carrying out homomorphic encryption to the third identity verification ID; a fifth step of generating, by the repository, a value which is calculated by carrying out a second arithmetic operation to a first random value (r1), the third homomorphic encryption value, a second random value (r2), a third random value (r3) and Ze, as a fourth homomorphic encryption value which is a value calculated by carrying out homomorphic encryption to a tag; a sixth step of transmitting, by the repository, a session ID, the third homomorphic encryption value, the fourth homomorphic encryption value, a first constant (G) and a second constant (P), to the user terminal; a seventh step of receiving, by the repository, the session ID, ID_3$(=G^{ID_3} (mod P)) and tag$(=G^{tag} (mode P)) from the user terminal; and an eighth step of storing, by the repository, the third identity verification ID and the identity verification information, if tag$ is identical to ID_3$^{r1}*G^{r2} (mod P).

A computer-implemented method of authenticating an identity after the digital identity is established according to another aspect of the present disclosure comprises a 2-1 step of receiving, by the account module, a first identity verification ID and a second validity verification value; a 2-2 step of generating, by the account module, a first hash value which is a value calculated by hashing the first identity verification ID and the second validity verification value; a 2-3 step of generating, by the account module, a second homomorphic encryption value which is a value calculated by carrying out homomorphic encryption to the second identity verification ID; a 2-4 step of generating, by the account module, a fifth validity verification value which is a value calculated by carrying out electronic signature to a fourth value including the second homomorphic encryption value and the first hash value; a 2-5 step of transmitting, by the account module, the fourth value and the fifth validity verification value to the user terminal; a 2-6 step of receiving, by the repository, the third identity verification ID, the fourth validity verification value, the fourth value, the fifth validity verification value and an encryption value (Ze) of zero, from the user terminal; a fifth step of generating, by the repository, a value calculated by carrying out a second arithmetic operation to a first random value (r1), the third homomorphic encryption value, a second random value (r2), a third random value (r3) and Ze, as a fourth homomorphic encryption value which is a value calculated by carrying out homomorphic encryption to the tag; a 2-8 step of transmitting, by the repository, a session ID, the third homomorphic encryption value, the fourth homomorphic encryption value, a first constant (G) and a second constant (P), to the user terminal; a 2-9 step of receiving, by the repository, the session ID, ID_3$(=G^{ID_3} (mod P)) and tag$(=G^{tag} (mod P)), from the user terminal; a 2-10 step of verifying, by the repository, the tag by determining whether tag$ is identical to ID_3$^{r1}*G^{r2} (mod P); a 2-11 step of generating, by the repository, the sixth validity verification value by carrying out electronic signature to a fifth value including the fifth validity verification value; a 2-12 step of transmitting, by the repository, a fourth value, the fifth validity verification value, and the sixth validity verification value, to the user terminal; a 2-13 step of receiving, by the account module, the first identity verification ID, the second validity verification value, the fourth value, the fifth value, the fifth validity verification value and the sixth validity verification value, from the user terminal; a 2-14 step of verifying, by the account module, the fifth validity verification value and the sixth validity verification value; a 2-15 step of verifying, by the account module, the first identity verification ID, the second validity verification value, and the first hash value; and a 2-16 step of generating a token and transmitting the token to the user terminal, by the account module.

A computer-implemented method of establishing a digital identity by registering a repository after an account module is registered according to another aspect of the present disclosure comprises a 1-1 step of receiving, by the repository, identity verification information, a second homomorphic encryption value which is calculated by carrying out homomorphic encryption to a second identity verification ID, a third validity verification value which is calculated by carrying out electronic signature to the second homomorphic encryption value, and an encryption value (Ze) of zero, from the user terminal; a 2-1 step of verifying, by the repository, the third validity verification value; a 3-2 step of querying, by the repository, the identity verification information; a 4-1 step of generating, by the repository, the third homomorphic encryption value which is a value calculated by carrying out homomorphic encryption to the third identity verification ID; a 5-1 step of generating, by the repository, a value which is calculated by carrying out a second arithmetic operation to a first random value (r1), the third homomorphic encryption value, a second random value (r2) and Ze, as a fourth homomorphic encryption value which is calculated by carrying out homomorphic encryption to a tag; a 6-1 step of transmitting, by the repository, a session ID, the third homomorphic encryption value, the fourth homomorphic encryption value, a first constant (G) and a second constant (P), to the user terminal; a 7-1 step of receiving, by the repository, the session ID, ID_3$(=G^{ID_3} (mod P)) and tag$(=G^{tag} (mod P)), from the user terminal; an 8-1 step of storing, by the account module, the third identity verification ID and the identity verification information, if tag$ is identical to ID_3$^{r1}*G^{r2} (mod P)); a 9-1 step of generating, by the repository, a fourth validity verification value which verifies the third identity verification ID; a 10-1 step of generating, by the repository, a ninth validity verification value for the third value and the third validity verification value; an 11-1 step of transmitting, by the repository, the fourth validity verification value and the ninth validity verification value, to the user terminal; a 12-1 step of receiving, by the account module, a request for registering the repository along with the first identity verification ID, the third value, the third validity verification value and the ninth validity verification value, from the user terminal; and a 13-1 step of registering, by the account module, the repository, if the verification of the third validity verification value and the ninth validity verification value is successful.

According to the present disclosure, personal information is unnecessary for establishing a unique digital identity for an entity which is confirmed to exist in real world or verifying a credential. Further, no personal information identifying the entity is necessary for carrying out activities in online Therefore, a privacy can be reserved in online environment.

### BRIEF DESCRIPTION OF THE DRAWINGS

The present disclosure will be more fully understood from the following detailed description taken in conjunction with the accompanying drawings.

FIGS. 1 and 2 show a process of establishing an anonymous digital identity according to the present disclosure.

FIG. 3 shows a process of registering the account module for establishing an anonymous digital identity according to another embodiment of the present disclosure.

FIGS. 4 and 5 show a process of registering identity verification information after the account module is registered.

FIGS. 6 and 7 show a process of an embodiment of authenticating the user after an anonymous digital identity is established according to the present disclosure.

FIGS. 8 and 9 shows a process of another embodiment of authenticating the user after an anonymous digital identity is established according to the present disclosure.

FIGS. 10 and 11 show a process of establishing an anonymous digital identity where a tag is verified according to another embodiments of the present disclosure.

FIGS. 12 and 13 show a process of registering identity verification information shown in FIGS. 4 and 5 where a tag is verified according to another embodiments of the present disclosure.

FIGS. 14 and 15 show a process of authenticating the user shown in FIGS. 6 and 7 where a tag is verified according to another embodiments of the present disclosure.

FIGS. 16 and 17 show a process of authenticating the user shown in FIGS. 8 and 9 where a tag is verified according to another embodiments of the present disclosure.

FIG. 18 shows a block diagram of the unlimited exemplary device, module or unit which carries out the present disclosure.

It should be understood that the above-referenced drawings are not necessarily to scale, presenting a somewhat simplified representation of various preferred features illustrative of the basic principles of the disclosure. The specific design features of the present disclosure will be determined in part by the particular intended application and use environment.

### DETAILED DESCRIPTION

Hereinafter, the present disclosure will be described in detail with reference to the accompanying drawings.

In this specification, transmitting/receiving of information (data) can be carried out with encryption/decryption if necessary. It should be understood that transmitting/receiving described in this specification can be carried out with encryption / decryption although not specifically mentioned. Further, transmitting (forwarding) to B from A or receiving by A from B include the process via an additional medium, not limited to direct transmitting or receiving. The order of each step should be understood in a non-limited manner unless a preceding step must be performed logically and temporally before a following step. That is, except for the exceptional cases as described above, although a process described as a following step is preceded by a process described as a preceding step, it does not affect the nature of the present disclosure, and the scope of rights should be defined regardless of the order of the steps. In addition, in this specification, “A or B” is defined not only as selectively referring to either A or B, but also as including both A and B. In addition, in this specification, the term “comprise” has a meaning of further including other components in addition to the components listed.

The term “module” or “unit” means a logical combination of a universal hardware and a software carrying out required function.

In this specification, the essential elements for the present disclosure will be described and the non-essential elements may not be described. However, the scope of the present disclosure should not be limited to the invention including only the described components. Further, the invention which includes additional element or does not have non-essential elements can be within the scope of the present disclosure.

The present disclosure can be carried out by an electronic arithmetic device such as a computer. The arithmetic operation and calculation which will be described hereinafter can be carried out by the known computing codes for the operation or calculation, or the computing codes which is appropriately conceived for the present disclosure.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. The term “coupled” denotes a physical relationship between two components whereby the components are either directly connected to one another or indirectly connected via one or more intermediary components. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The method according to the present disclosure can be carried out by an electronic arithmetic device such as a computer, tablet, mobile phone, portable computing device, stationary computing device, etc. Additionally, it is understood that one or more various methods, or aspects thereof, may be executed by at least one processor. The processor may be implemented on a computer, tablet, mobile device, portable computing device, etc. A memory configured to store program instructions may also be implemented in the device(s), in which case the processor is specifically programmed to execute the stored program instructions to perform one or more processes, which are described further below. Moreover, it is understood that the below information, methods, etc. may be executed by a computer, tablet, mobile device, portable computing device, etc. including the processor, in conjunction with one or more additional components, as described in detail below. Furthermore, control logic may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a remote fashion, e.g., by a telematics server or a Controller Area Network (CAN).

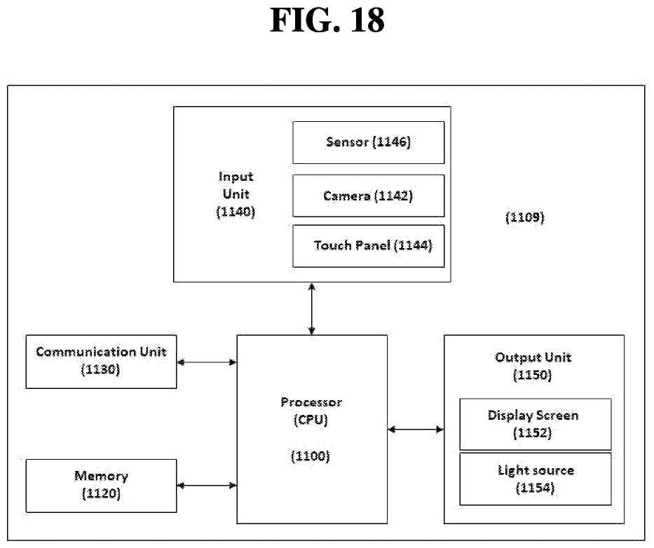

FIG. 18 illustrates an example diagrammatic view of an exemplary device architecture according to embodiments of the present disclosure. As shown in FIG. 18, a device (1109) may contain multiple components, including, but not limited to, a processor (e.g., central processing unit (CPU; 1100), a memory (1120), a wired or wireless communication unit (1130), one or more input units (1140), and one or more output units (1150). It should be noted that the architecture depicted in FIG. 18 is simplified and provided merely for demonstration purposes. The architecture of the device (1109) can be modified in any suitable manner as would be understood by a person having ordinary skill in the art, in accordance with the present claims. Moreover, the components of the device (1109) themselves may be modified in any suitable manner as would be understood by a person having ordinary skill in the art, in accordance with the present claims. Therefore, the device architecture depicted in FIG. 18 should be treated as exemplary only and should not be treated as limiting the scope of the present disclosure.

The processor (1110) is capable of controlling operation of the device (1109). More specifically, the processor (1110) may be operable to control and interact with multiple components installed in the device (1109), as shown in FIG. 18. For instance, the memory (1120) can store program instructions that are executable by the processor (1100) and data. The process described herein may be stored in the form of program instructions in the memory (1120) for execution by the processor (1100). The communication unit (1130) can allow the device (1109) to transmit data to and receive data from one or more external devices via a communication network. The input unit (1140) can enable the device (1109) to receive input of various types, such as audio/visual input, user input, data input, and the like. To this end, the input unit (1140) may be composed of multiple input devices for accepting input of various types, including, for instance, one or more cameras (1142) (i.e., an “image acquisition unit”), touch panel (1144), microphone (not shown), sensors (1146), keyboards, mice, one or more buttons or switches (not shown), and so forth. The term “image acquisition unit,” as used herein, may refer to the camera (1142), but is not limited thereto. The input devices included in the input (1140) may be manipulated by a user. The output unit (1150) can display information on the display screen (1152) for a user to view. The display screen (1152) can also be configured to accept one or more inputs, such as a user tapping or pressing the screen (1152), through a variety of mechanisms known in the art. The output unit (1150) may further include a light source (1154). The device (1109) is illustrated as a single component, but the device may also be composed of multiple, separate components that are connected together and interact with each other during use.

The term “value” described in this specification is defined as being universal value which includes vector, matrix, tensor and polynomial as well as scholar value.

In this specification, the encryption or hash of a specific value includes the encryption or hash of a value derived from the specific value. The value to be encrypted or hashed can be derived by carrying out arithmetic operation to the specific value.

In this specification, HE(*) means a homomorphic encryption value of *.

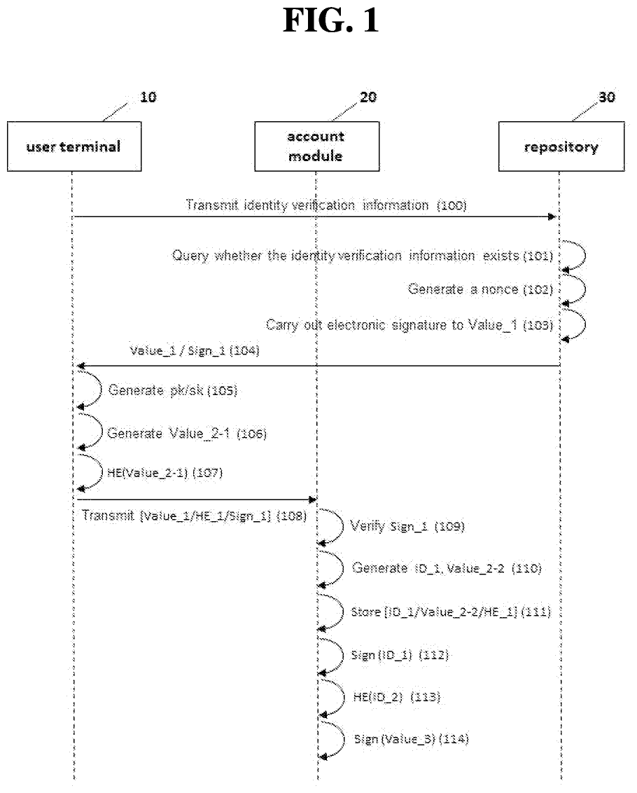

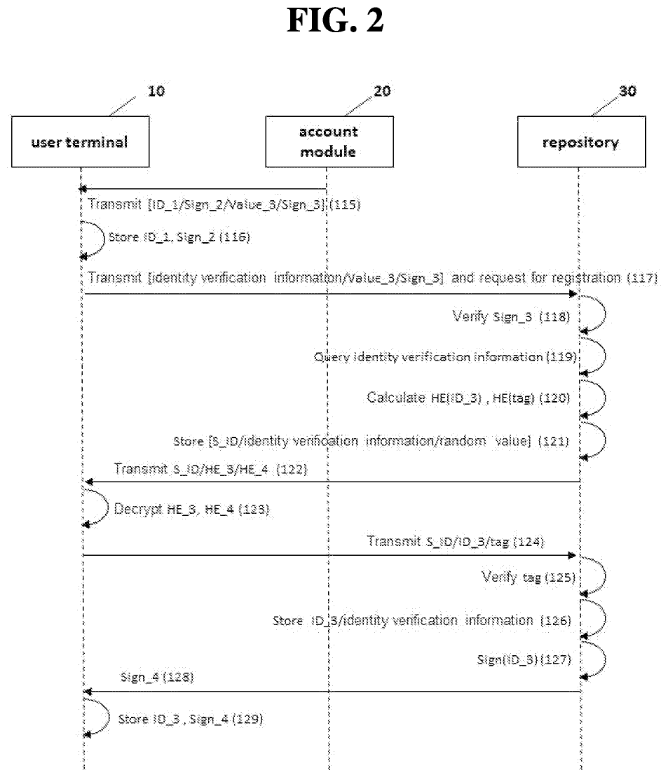

FIGS. 1 and 2 show a process of establishing an anonymous digital identity according to the present disclosure. In this specification, “anonymous digital identity” means an object which cannot identify who he/she is in the off-line environment but can define a unique identity in digital environment. The digital identity includes a predetermined credential.

The method of registering identity verification information according to the present disclosure can be carried out in the environment comprising a user terminal (10), an account module (20), and a repository (30) for storing identity verification information.

Each account module (20) has a unique identification information and is generated for each user. The account module (20) can be included in a block chain. A user can carry out an activity or work in online environment through the account module (20) which is uniquely provided to the user. The account module (20) does not have a user information and just has a token which verifies an anonymous digital identity as described hereinafter. Various tokens for verifying digital identity can be provided to a user, thereby enabling the user to use various online services with the token.

The repository (30) stores a second ID (ID_2) and identity verification information. There can be a plurality of the repositories (30) depending on the categories of the digital identity or credential.

In step (100), the identity verification information entered in the user terminal (10) is transmitted to the repository (30). For example, the identity verification information can be biometric information such as iris, fingerprint and vein pattern or identification card information such as citizen registration card, passport, drive license, job certificate and the like. According to the present disclosure, the owner of the stored identity verification information cannot be disclosed because an anonymous digital identity is established as described hereinafter. The user terminal (10) can request a token for verifying the identity to the account module (20) prior to transmitting the identity verification information to the repository (30). In this specification, “identity verification” includes verification of minor/adult status, nationality and the like as well as verification of an anonymous digital identity.

In the step (101), the repository (30) checks whether the received identity verification information is previously stored in the repository (30). If it is previously stored one, the repository (30) rejects the registration and otherwise generates a nonce (N_nonce) in the step (102).

In the step (103), the repository (30) carries out electronic signature to a first value (Value_1) including the nonce. The first value can further include time information (date_r) of the repository (30) for verification of the time validity of the first value later. The time validity can enhance security because a value is valid only during a predetermined period.

Although the term of “validity verification value” or “electronic signature” is described in this specification, any alternative way can be used as long as it can determine whether information is forged or altered. Validity verification value can include conventional electronic signature value.

In the step (104), the repository (30) transmits a first value (Value_1) and a first validity verification value (Sign_1).

The steps (100 to 104) are necessary for checking whether identity verification information is previously stored in the repository (30). The steps (100 to 104) can prevent unnecessary data from being generated in duplicate in the steps (109-115).

In the step (105), the user terminal (10) generates a key for homomorphic encryption. Homomorphic encryption can use public key scheme or symmetric key scheme. In the step (106), the user terminal (10) generates a 2-1 random value (Value_2-1; Re); and generates a first homomorphic encryption value (HE_1) which is calculated by carrying out homomorphic encryption to the 2-1 random value (Value_2-1; Re) in the step (107).

In the step (108), the user terminal (10) transmits the first value (Value_1), the first homomorphic encryption value (HE_1) and the first validity verification value (Sign_1) to the account module (20).

In the step (109), the account module (20) verifies the first validity verification value (Sign_1). If the verification is successful, the account module (20) generates a first identity verification ID (ID_1) and a 2-2 random value (Value_2-2; Ra) in the step (110).

The account module (20) has a unique account module identification information for each user. The first identity verification ID (ID_1) can act as a role of the account module identification information. The 2-2 random value (Value_2-2) can guarantee the randomness of the second identity verification ID (ID_2) which will be described in the below.

In the step (111), the account module (20) stores the first identity verification ID (ID_1), the 2-2 random value (Value_2-2) and the first homomorphic encryption value (HE_1).

The account module (20) can carry out electronic signature to the first identity verification ID (ID_1) to generate a second validity verification value (Sign_2). Alternative value can be generated as long as the value can verify that the first identity verification ID (ID_1) is generated by the account module (20) and verify the integrity and the validity of the ID.

In the step (113), the account module (20) generates a second homomorphic encryption value (HE_2) which is a value calculated by carrying out homomorphic encryption to a second identity verification ID (ID_2). The second identity verification ID (ID_2) can be generated by carrying out one-way function operation for example, hash operation to a value including the first identity verification ID (113_1). For example, the second identity verification ID (ID_2) can be calculated as follows:

HE(ID_2)=Hash[ID_1, Value_2-2, HE(Value_2-1)]=HE[Hash (ID_1, Value_2-2, Value_2-1)]

That is, ID_2 can be “Hash (ID_1, Value_2-2, Value_2-1).”

In the step (114), the account module (20) carries out electronic signature to a third value (Value_3) including the second homomorphic encryption value (I-IE_2) to generate a third validity verification value (Sign_3). The third value can include time information (date_a) of the account module (20) for verification of the time validity of the third value later.

The account module (20) transmits the first identity verification ID (ID_1), the second validity verification value (Sign_2), the third value (Value_3) and the third validity verification value (Sign_3) to the user terminal.

In the step (116), the user terminal (10) stores the first identity verification ID (ID_1) and the second validity verification value (Sign_2).

In the step (117), the user terminal (10) transmits the identity verification information, the third value (Value_3), and the third validity verification value (Sign_3) to the repository (30) to request registration of the identity verification information.

The repository (30) verifies the third validity verification value (Sign_3) in the step (118) and check whether the identity verification information exists in the step (119).

The repository (30) generates a third homomorphic encryption value (HE_3) which is a value calculated by carrying out homomorphic encryption to a third identity verification ID (ID_3) and a fourth homomorphic encryption value (HE_4) which is a value calculated by carrying out homomorphic encryption to a tag.

The third identity verification ID (ID_3) can be generated by carrying out one-way function operation (for example, hash operation) to a value including the second homomorphic encryption value (HE_2). For example, the third identity verification ID (ID_3) can be generated as follows:

HE(ID_3)=Hash[HE_2, ID of repository]=HE[Hash(ID_2, ID of repository)]

That is, ID_3 can be “Hash (ID_2, ID of repository).”

The fourth homomorphic encryption value (HE_4) can be obtained by carrying out a first arithmetic operation to a random value generated by the repository (30) and the third homomorphic encryption value (HE_3).

For example, the first arithmetic operation is defined as multiplying a first random value (r1) by the third homomorphic encryption value (HE_3) and then adding a second random value (r2) to the result of the multiplication. The operation can be expressed as follows:

r1*HE_3+r2=HE(r1*ID_3+r2)=HE(tag)=HE_4

That is, tag can be “r1*ID_3+r2.”

The first arithmetic operation can be defined as multiplying a first random value (r1) by the third homomorphic encryption value (HE_3) and then subtracting a second random value (r2) from the result of the multiplication. Alternatively, the first arithmetic operation can be defined as multiplying a first random value (r1) by the third homomorphic encryption value (HE_3) and then adding a second random value (r2) to the negative value of the result of the multiplication or subtracting a second random value (r2) from the negative value of the result of the multiplication.

The function f₁ which satisfies the following relation can be defined as the first arithmetic operation.

f₁(r1, HE_3, r2)=HE(f₁(r1, ID_3, r2))

The first arithmetic operation can include XOR operation. In that case, the following relation can be satisfied:

XOR(r1, HE_3)=HE(XOR(r1, ID_3))

In the step (121), the repository (30) stores a session ID (S_ID), the identity verification information, and the generated random values. As described, the identity verification information can include any information which verifies the uniqueness of the user, such as biometric information, identity certificate information and the like.

In the step (122), the repository (30) transmits the session ID (S_ID), the third homomorphic encryption value (HE_3), and the fourth homomorphic encryption value (HE_4) to the user terminal (10).

In the step (123), the user terminal (10) decrypts the third homomorphic encryption value (HE_3) and the fourth homomorphic encryption value (HE_4) to obtain the third identity verification ID (ID_3) and the tag.

In the step (124), the user terminal (10) transmits the session ID (S_ID), the third identity verification ID (ID_3) and the tag to the repository (30).

In the step (125), the repository (30) verifies the tag received in the step (124). If the result of the first arithmetic operation to the third identity verification ID (ID_3) received in the step (124) and the random values is identical to the tag, it is determined that the verification is successful. Otherwise, it is determined that the verification fails.

In the step (126), the repository (30) associates the third identity verification ID (ID_3) with the identity verification information and then stores them.

The repository (30) carries out electronic to the third identity verification ID (ID_3) to generate a fourth validity verification value (Sign_4) and transmits the fourth validity verification value (Sign_4) to the user terminal (10). Alternative value can be generated as long as the value can verify that the third identity verification ID (ID_3) is generated by the repository (30) and verify the integrity and the validity of the ID_3.

In the step (129), the user terminal (10) stores the third identity verification ID (ID_3) and the fourth validity verification value (Sign_4) and then terminates the process of storing the identity verification information.

According to the present disclosure, any information which can identify the user is not stored in the repository (30) but the uniqueness of the user can be guaranteed. Thus, anonymity and uniqueness of the user can be guaranteed in online environment.

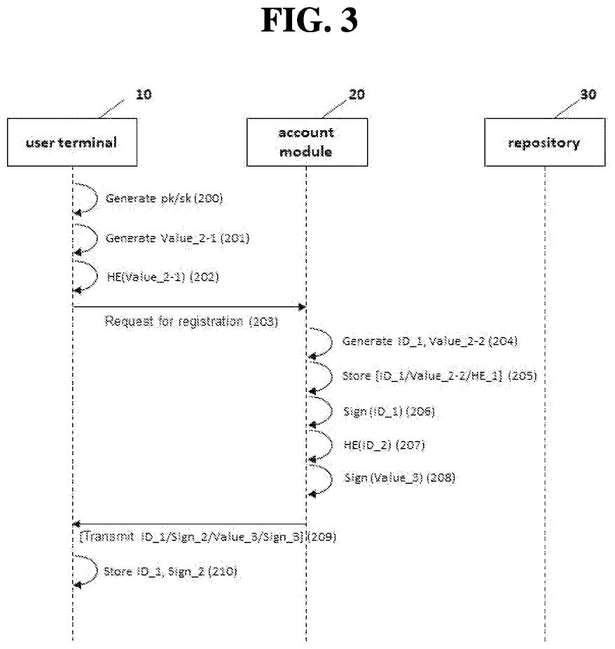

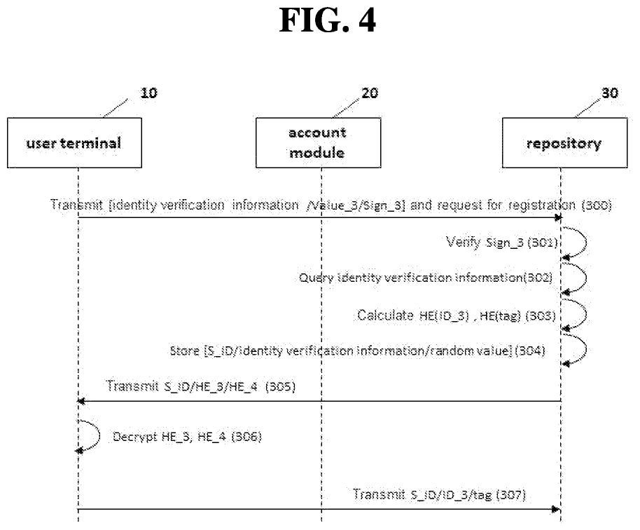

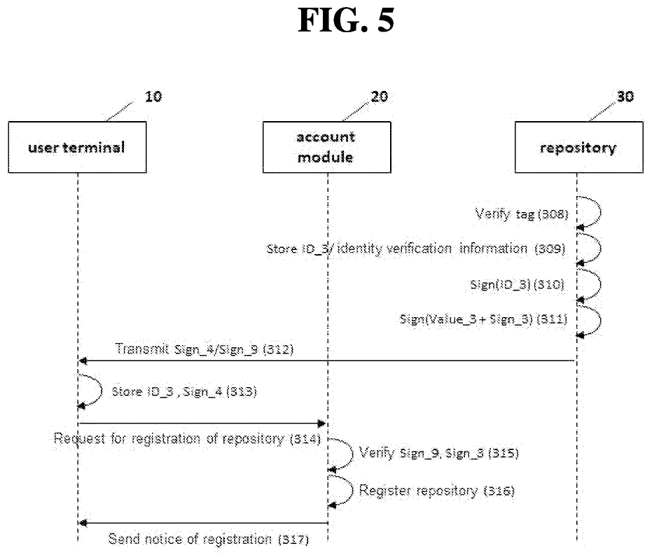

FIG. 3 shows a process that the user terminal directly requests for the account module (20) to establish an anonymous digital identity and registers the account module. FIGS. 4 and 5 show the process of registering the identity verification information after the account module is registered.

The steps (200 to 202) of FIG. 3 correspond to the steps (105-107) of FIG. 1, and thus the explanation thereof is not described.

In the step (203), the user terminal (10) requests the registration to the account module (20). At that time, the first homomorphic encryption value (HE_1) can be transmitted. The steps (204 to 210) correspond to the steps (110-116) of FIGS. 1 and 2, and thus the explanation thereof is not described.

After the registration of the account module is completed according to the process shown in FIG. 3, the process of registering the repository is carried out as shown in FIGS. 4 and 5.

The steps (300 to 310) correspond to the steps (117-127) of FIG. 2 and thus the explanation thereof is not described.

The repository (30) carries out electronic signature to an eighth value (Value_8) including the third value (Value_3) and the third validity verification value (Sign_3) to generate a ninth validity verification value (Value_9). The eighth value (Value_8) can further include time information (date_r) of the repository (30) for verification of time validity later.

In the step (312), the repository (30) transmits the fourth validity verification value (Sign_4) and the ninth validity verification value (Sign_9) to the user terminal (10). At that time, the time information (date_r) of the repository (30) can be further transmitted.

In the step (313), the user terminal (10) stores the third identity verification ID (ID_3) which is obtained by the decryption in the step (306), and the fourth validity verification value (Sign_4). In the step (314), the user terminal (10) requests for the account module (20) to register the repository (30). For the request, the user terminal can transmit the first identity verification ID (ID_1), the third value (Value_3), the third validity verification value (Sign_3) and the ninth validity verification value (Sign_9) to the account module (20). The time information (date_r) of the repository (30) can be further transmitted.

The account module (20) verifies the third validity verification value (Sign_3) and the ninth validity verification value (Sign_9) in the step (315) and registers the repository in the step (316). Thereafter, the account module transmits the notice of registration to the user terminal in the step (317).

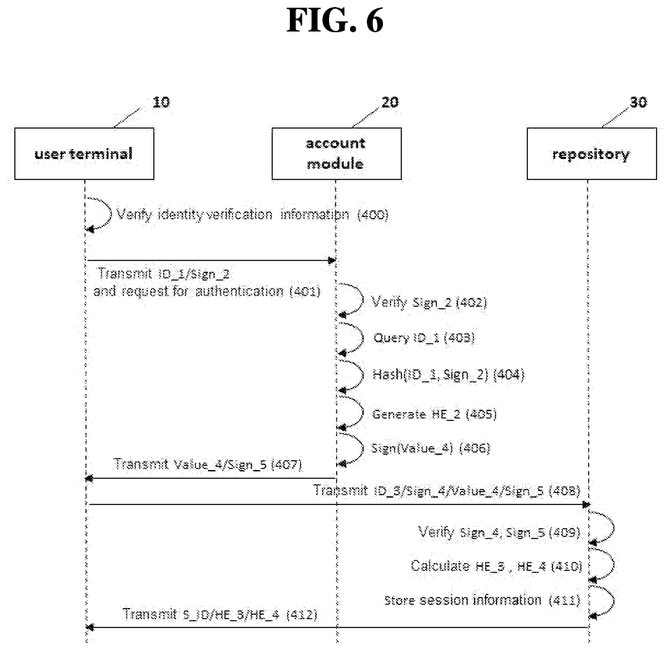

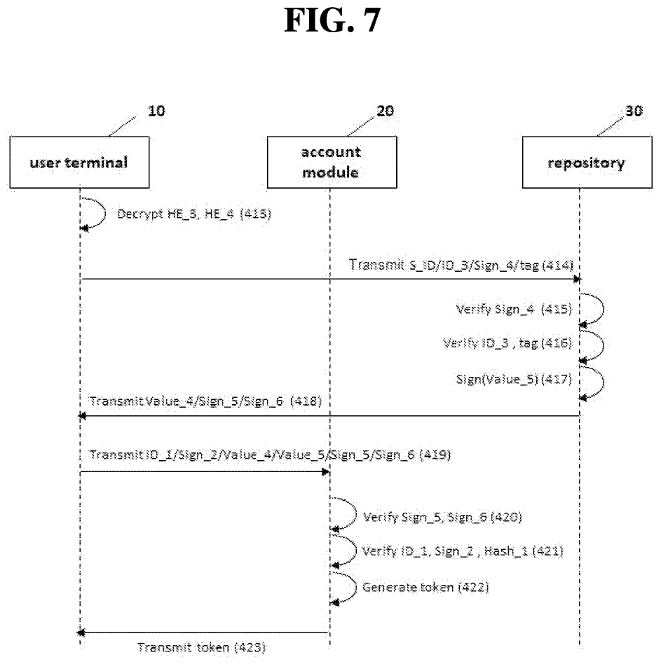

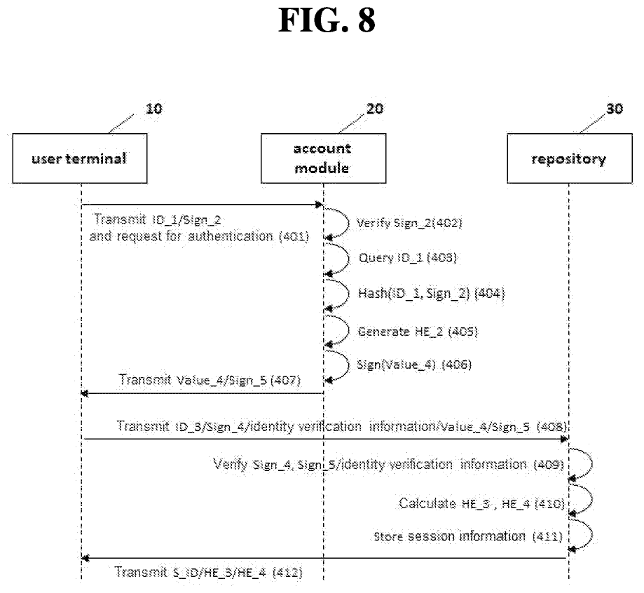

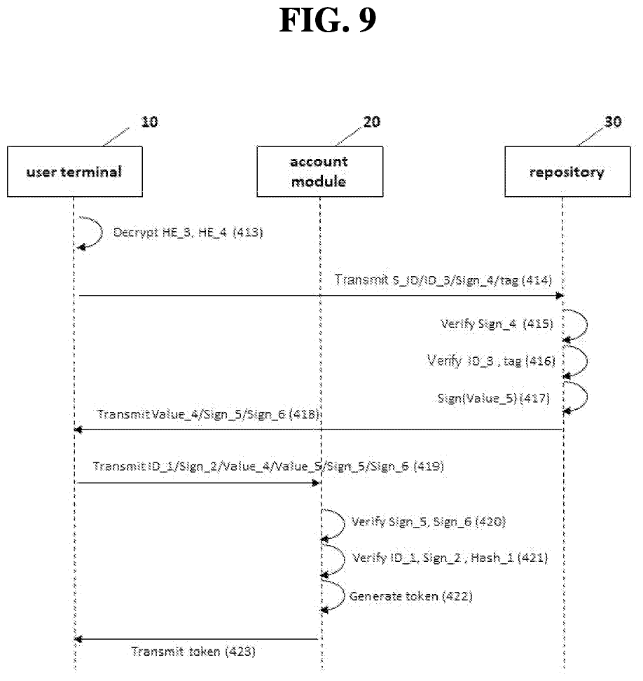

FIGS. 6 to 9 show the flow chart of the authentication process after the anonymous digital identity is established according to the present disclosure. The embodiments shown in FIGS. 6 and 7 do not use the identity verification information stored in the repository (30) for authentication. The embodiments shown in FIGS. 8 and 9 uses the identity verification information stored in the repository (30) for authentication.

In the step (400), the user terminal (10) verifies the identity verification information of a user. For example, the user terminal (10) such as a smartphone and the like verifies the entered information relating to iris or fingerprint.

The user terminal transmits the first identity verification ID (ID_1) and the second validity verification value (Sign_2) to the account module (20) and request for authentication.

The account module (20) verifies the second validity verification value (Sign_2) in the step (402) and queries the first identity verification ID (ID_1) in the step (403) if the verification is successful.

In the step (404), the account module (20) carries out hash to the first identity verification ID (ID_1) and the second validity verification value (Sign_2) to generate a first hash value (Hash_1).

In the step (405), the account module (20) generates the second homomorphic encryption value (HE_2).

In the step (406), the account module (20) carries out electronic signature to a fourth value (Value_4) including the first hash value (Hash_1) and the second homomorphic encryption value (HE_2) to generate a fifth validity verification value (Sign_5). The fourth value (Value_4) can include time information (date_a) of the account module for verification of time validity later.

In the step (407), the account module (20) transmits the fourth value (Value_4) and the fifth validity verification value (Sign_5) to the user terminal (10).

In the step (408), the user terminal (10) transmits the third identity verification ID (ID_3) along with the information received in the step (407) to the repository (30). In the embodiments shown FIG. 8, the identity verification information is also transmitted.

The repository (30) verifies the fourth and fifth validity verification values (Sign_4, Sign_5) in the step (409); calculates the third homomorphic encryption value (HE_3) and the fourth homomorphic encryption value (HE_4) in the step (410); and stores a session information in the step (411). In the embodiments shown in FIGS. 8 and 9, the identity verification information is further verified in the step (409).

The third and fourth homomorphic encryption values (HE_3, HE_4) can be generated in accordance with the methods explained in the above with reference to FIGS. 1 and 2.

The stored session information includes a session ID (S_ID), the random values which are used for generating the tag, the third identity verification ID (ID_3), the fourth value (Value_4), and the fifth validity verification value (Sign_5).

In the step (412), the repository (30) transmits the session ID (S_ID), the third homomorphic encryption value (HE_3) and the fourth homomorphic encryption value (HE_4) to the user terminal (10).

In the step (413), the user terminal (10) decrypts the third homomorphic encryption value (HE_3) and the fourth homomorphic encryption value (HE_4) to obtain the third identity verification ID (ID_3) and the tag.

In the step (414), the user terminal (10) transmits the session ID (S_ID), the third identity verification ID (ID_3), the fourth validity verification value (Sign_4) and the tag to the repository (30).

The repository (30) verifies the fourth validity value (Sign_4) in the step (415) and verifies the third identity verification ID (ID_3) and the tag if the verification of the fourth validity value is successful.

The third identity verification ID (ID_3) can be verified by determining whether the third identity verification ID (ID_3) received from the user terminal (10) is identical to the third identity verification ID (ID_3) calculated from the second homomorphic encryption value (HE_2) received in the step (208).

The verification of the tag can be carried out by the method explained in the above with reference to FIGS. 1 and 2.

In the step (417), the repository (30) carries out electronic signature to a fifth value (Value_5) including the fifth validity verification value (Sign_5) to generate a sixth validity verification value (Sign_6). The fifth value (Value_5) can include time information (date_r) of the repository (30) for verification of time validity that a value is valid during a predetermined period and is not valid otherwise.

In the step (418), the repository (30) transmits a fourth value (Value_4), the fifth validity verification value (Sign_5) and the sixth validity verification value (Sign_6) to the user terminal (10).

In the step (419), the user terminal (10) transmits the first identity verification ID (ID_1), the second validity verification value (Sign_2), the fourth value (Value_4), the fifth value (Value_5), the fifth validity verification value (Sign_5), and the sixth validity verification value (Sign_6) to the account module (20).

The account module (20) verifies the fifth validity verification value (Sign_5) and the sixth validity verification value (Sign_6) in the step (420) and verifies the first identity verification ID (ID_1), the second validity verification value (Sign_2) and the first hash value (Hash_1) in the step (421).

If the verification is successful, the account module (20) generates a token in the step (422) and transmits a token to the user terminal (10) in the step (423).

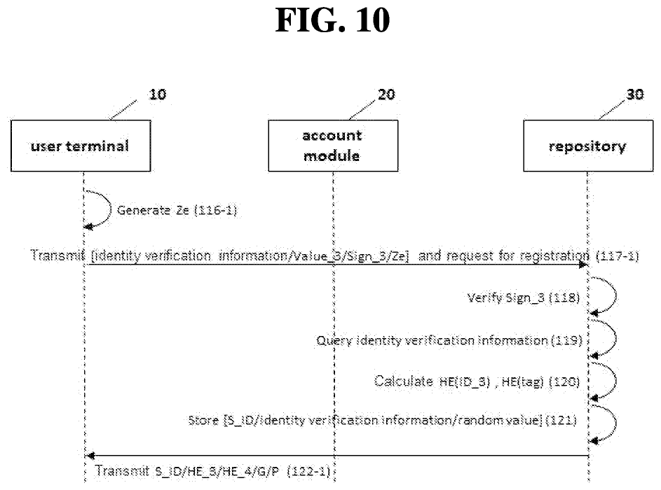

FIGS. 10 to 17 shows another embodiments of verifying the tag in the process shown in FIGS. 1, 2, 4 to 9. The repository (30) has constants G and P in the embodiments shown in FIGS. 10 to 17.

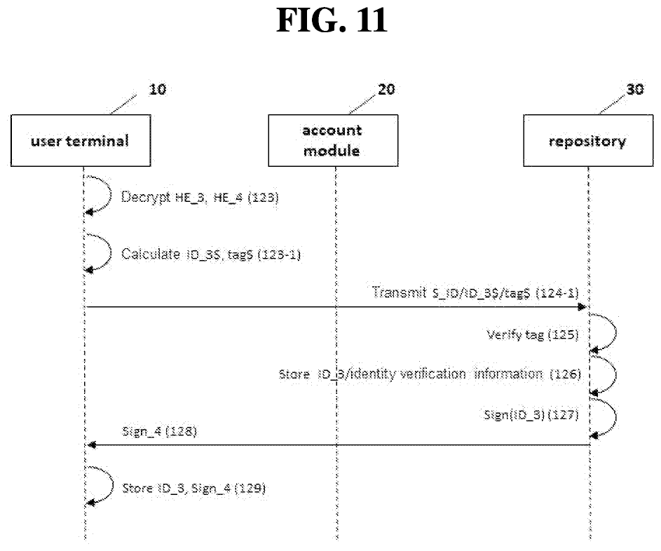

FIGS. 10 and 11 show another embodiments of verifying the tag in the process of establishing an anonymous digital identity, which is different from the embodiments of FIGS. 1 and 2.

The steps (100 to 116) of FIGS. 1 and 2 are also carried out in the embodiments shown in FIGS. 10 and 11 and thus the steps are not shown for simple illustration. The steps explained with reference to FIGS. 1 and 2 are not described in the embodiments of FIGS. 10 and 11.

In the step (116-1), the user terminal (10) generates the encryption value (Ze) of zero prior to requesting for registration. In the step (117-1), the user terminal (10) transmits further the value (Ze) along with the values transmitted in the step (117) to the repository (30) when it requests for the repository to register an anonymous digital identity.

In the step (120), the repository (30) carries out homomorphic encryption to the third identity verification ID (ID_3) and the tag to produce HE_3 and HE_4, respectively.

The tag can be calculated in FIGS. 10 and 11 as follows:

HE(tag)=r1*HE_3+r2+r3*Ze=HE(r1*ID_3+r2+r3*Ze)

According to the above equation, tag is ″r1*ID_3+r2+r3Ze.

The embodiments are different from the embodiments of FIGS. 1 and 2 in that one more random value is necessary and the value (Ze) is used for generating the tag. Another different arithmetic operation can be used for generating the tag. For example, tag can be ″r1*ID_3−r2−r3*Ze. The embodiments of FIGS. 10 to 17 can use an arithmetic operation which adds r3*Ze to the result of the first arithmetic operation or subtracts r3*Z3 from the result of the first arithmetic operation.

In this specification, the arithmetic operation used in the embodiments of FIGS. 10 to 17 is defined as a second arithmetic operation. The second arithmetic operation means the function f₂ which satisfies the following relationship:

f₂(r1, HE_3, r2, r3, Ze)=HE[f₂(r1, ID_3, r2, r3, Ze)]

In the step (122-1), the repository (30) transmits a session ID (S_ID), the third and fourth homomorphic encryption values, G and P to the user terminal (10).

In the step (123), the user terminal (10) decrypts HE_3 and HE_4 to obtain ID_3 and the tag. The user terminal (10) calculates ID_3$ and tag$ in the step (123-1).

ID_3$ and tag$ means a result of a predetermined arithmetic operation to ID_3 and tag, respectively. For example, ID_3$ and tag$ can be calculated as follows:

ID_3$=G^{ID_3}(mod P)

tag$=G^{tag}(mod P)

In the step (124), the user terminal (10) transmits the ID_3$ and tag$ along with the session ID (S_ID) to the repository (30).

The repository (30) verifies the tag in the step (125). The verification can be carried out as follows:

tag$=?ID_3$^{r1}*G^{r2}(mod P)

The tag is verified by determining whether the tag$ received in the step (124) is identical to the right side.

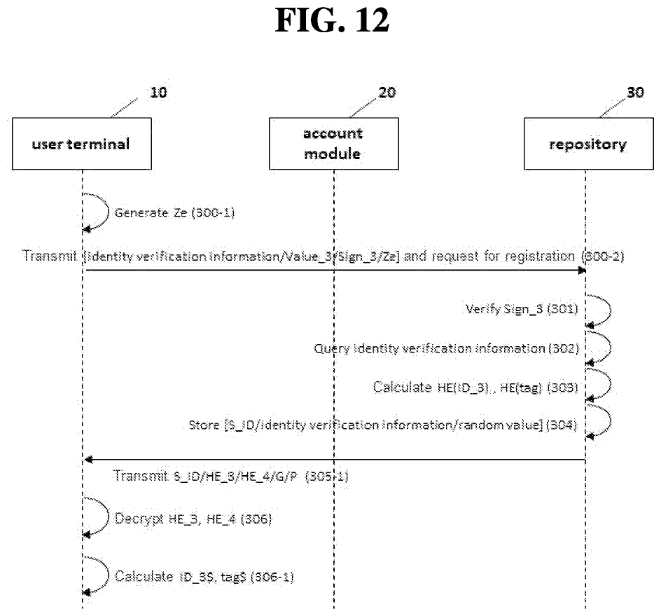

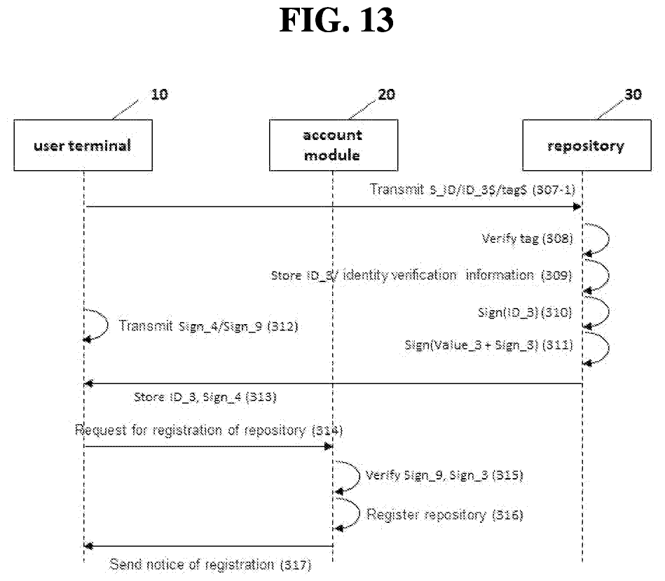

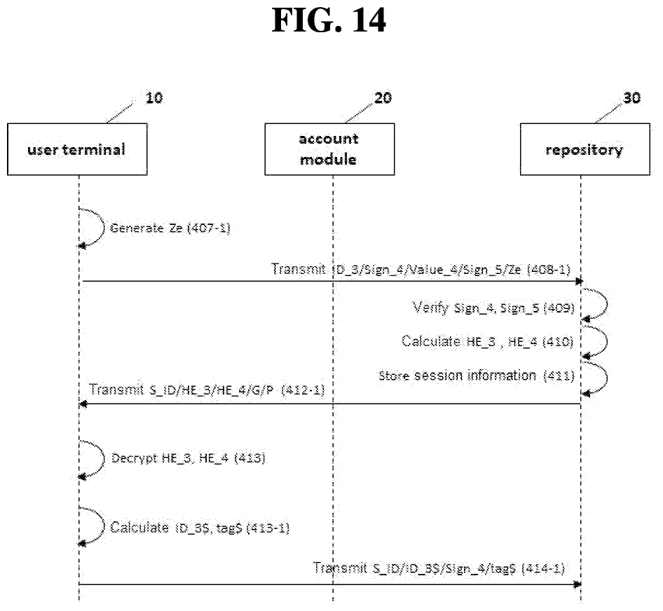

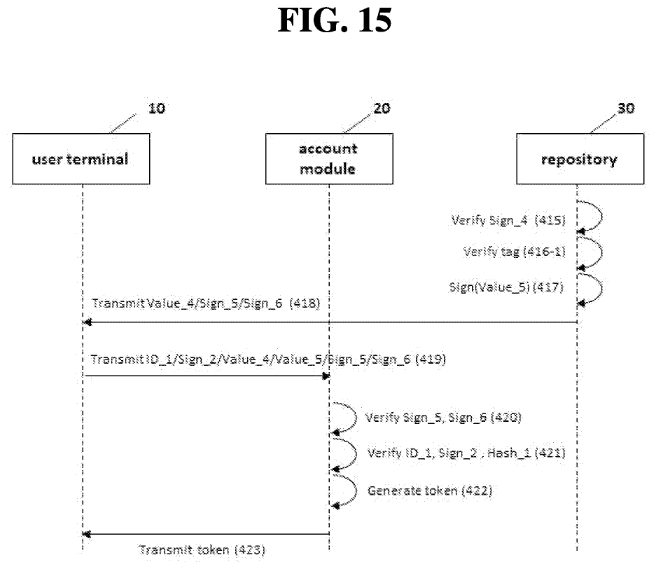

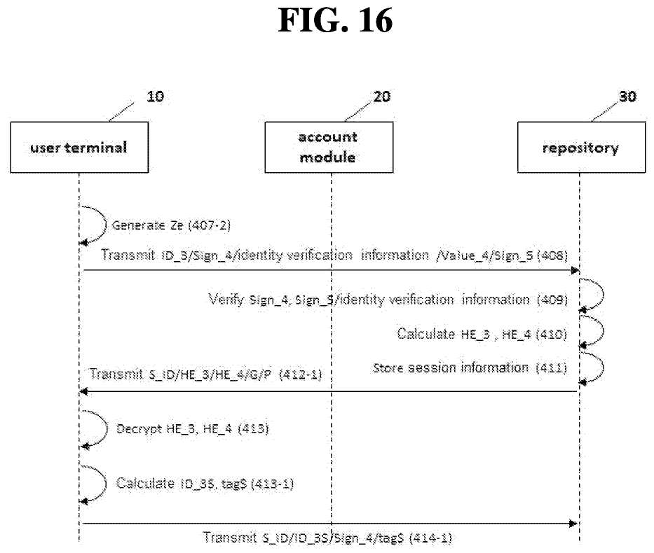

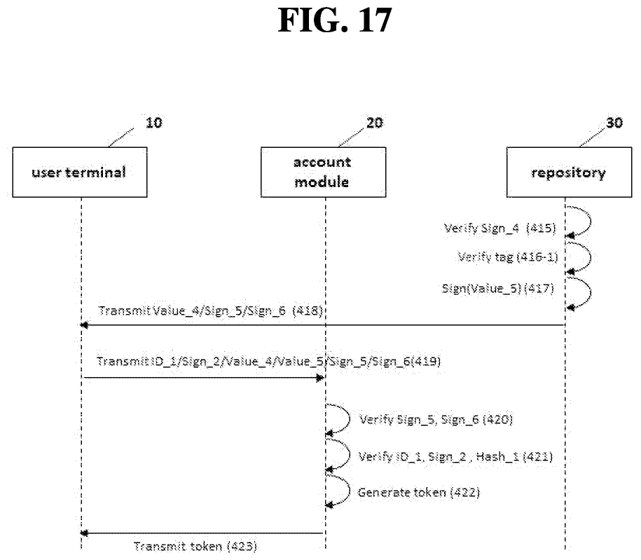

FIGS. 12 and 13 show a process wherein another verification method of the tag is carried out for the embodiments of FIGS. 4 and 5; FIGS. 14 and 15 show a process wherein another verification method of the tag is carried out for the embodiments of FIGS. 6 and 7; and FIGS. 16 and 17 show a process wherein another verification method of the tag is carried out for the embodiments of FIGS. 8 and 9.

The method of verifying the tag in FIGS. 12 to 17 is substantially the same as the method of FIGS. 10 and 11.

The user terminal (10) can use the token as an authentication result when a user carries out an online activity which requires anonymity, such as electronic vote, online discussion, the activity requiring verification of credential (for example, verification of adult status) and the like. According to the present disclosure, a personal information need not to be disclosed and the anonymity is guaranteed when the authentication is carried out.

The identity verification information (for example, iris, fingerprint or identity certificate and the like) can be further transmitted in the embodiments of FIGS. 8 and 9 wherein the identity verification information is verified after being transmitted to the repository (30) without being verified in the user terminal. Further, the process for determining whether the identity verification information received in the repository (30) is identical to the identity verification information stored in the steps (126, 309), can be added.

According to the present disclosure, the account module and the repository do not communicate with each other in the registration process of identity verification information and the authentication process; the first identity verification ID (ID_1) and the third identity verification ID (ID_3) are generated by the account module and the repository, respectively; and the IDs cannot identify the owner of the IDs. Thus, the present disclosure provides digital identity that can reserve anonymity, privacy and uniqueness of the user.

Although the present disclosure has been described with reference to accompanying drawings, the scope of the present disclosure is determined by the claims described below and should not be interpreted as being restricted by the embodiments and/or drawings described above. It should be clearly understood that improvements, changes and modifications of the present disclosure disclosed in the claims and apparent to those skilled in the art also fall within the scope of the present disclosure.

What is claimed is:

1. A computer-implemented method of establishing a digital identity, which is carried out in an environment including a user terminal, an account module and a repository, the method comprising:
a first step of receiving, by the repository, an identity verification information, a second homomorphic encryption value which is a value calculated by carrying out homomorphic encryption to a second identity verification ID, a third validity verification value which is a value generated by carrying out electronic signature to the second homomorphic encryption value, from the user terminal;
a second step of verifying, by the repository, the third validity verification value;
a third step of verifying, by the repository, querying the identity verification information;
a fourth step of generating, by the repository, a third homomorphic encryption value which is a value generated by carrying out homomorphic encryption to the third identity verification ID;
a fifth step of generating, by the repository, a value which is calculated by carrying out a first arithmetic operation to a first random value, the third homomorphic encryption value and a second random value, as a fourth homomorphic encryption value which is a value calculated by carrying out homomorphic encryption to a tag;
a sixth step of transmitting, by the repository, a session ID, the third homomorphic encryption value and the fourth homomorphic encryption value, to the user terminal;
a seventh step of receiving, by the repository, the session ID, the third identity verification ID and the tag from the user terminal; and
an eighth step of storing, by the repository, the third identity verification ID and the identity verification information if the value calculated by carrying out the first arithmetic operation to the first random value, the third homomorphic encryption value and the second random value is identical to the tag received in the seventh step,
wherein the first identity verification ID is uniquely assigned to the account module for each user; the second identity verification ID is calculated by carrying out one-way function to a value including the first identity verification ID; and the third identity verification ID is calculated by carrying out one-way function to a value including the second homomorphic encryption value.

2. The computer-implemented method of claim 1, further comprising,
a 1-1 step of receiving, by the repository, the identity verification information from the user terminal;
a 1-2 step of determining, by the repository, whether the received identity verification information is the information which is previously stored;
a 1-3 step of generating a first validity verification value by carrying out electronic signature to a first value, by the repository, when it is determined that the identity verification information is not previously stored;
a 1-4 step of transmitting, by the repository, the first value and the first validity verification value to the user terminal;
a 1-5 step of receiving, by the account module, a first homomorphic encryption value which is a value calculated by carrying out homomorphic encryption to a 2-1 value generated by the user terminal, the first value, and the first validity verification value, from the user terminal;
a 1-6 step of generating, by the account module, a first identity verification ID;
a 1-7 step of storing, by the account module, the first identity verification ID and the first homomorphic encryption value;
a 1-8 step of generating, by the account module, a second validity verification value which verifies the first identity verification ID;
a 1-9 step of generating, by the account module, the second identity verification ID;
a 1-10 step of generating, by the account module, the second homomorphic encryption value by homomorphically-encryption the second identity verification ID;
a 1-11 step of generating, by the account module, a third validity verification value by carrying out electronic signature to a third value including the second homomorphic encryption value; and
a 1-12 step of transmitting, by the account module, the first identity verification ID, the second validity verification value, the third value, and the third validity verification value to the user terminal;
wherein the 1-1 step to the 1-12 step are carried out before the first step.

3. The computer-implemented method of claim 2, wherein the second identity verification ID is calculated by operating one-way function to the first identity verification ID, the 2-1 random value generated by the user terminal, and the 2-2 random value generated by the account module.

4. The computer-implemented method of claim 2, wherein the third homomorphic encryption value is calculated by operating one-way function to the second homomorphic encryption value and ID of the repository.

5. The computer-implemented method of claim 2, wherein the first value includes the nonce and time information of the repository.

6. The computer-implemented method of claim 2, wherein the third value further includes time information of the account module.

7. The computer-implemented method of claim 1, wherein the first arithmetic operation comprises at least the arithmetic operation as follows:
[(one of the third homomorphic encryption value and the third identity verification ID)×(one of the first random value and the second random value)]±(the other of the first random value and the second random value).

8. The computer-implemented method of claim 1, wherein the identity verification information comprises identity certificate information or biometric information.

9. A computer-implemented method of verifying identity after the digital identity is established according to claim 1, the method comprising:
a 2-1 step of receiving, by the account module, the first identity verification ID and the second validity verification value, from the user terminal;
a 2-2 step of generating, by the account module, a first hash value which is a value calculated by hashing the first identity verification ID and the second validity verification value;
a 2-3 step of generating, by the account module, the second homomorphic encryption value which is a value calculated by carrying out homomorphic encryption to the second identity verification ID;
a 2-4 step of generating, by the account module, a fifth validity verification value which is a value generated by carrying out electronic signature to a fourth value including the second homomorphic encryption value and the first hash value;
a 2-5 step of transmitting, by the account module, the fourth value and the fifth validity verification value;
a 2-6 step of receiving, by the repository, the third identity verification ID, the fourth validity verification value, the fourth value, and the fifth validity verification value, from the user terminal;
a 2-7 step of generating, by the repository, the fourth homomorphic encryption value which is a value calculated by homomorphically-encrypting the tag, by carrying out the first arithmetic operation to the third homomorphic encryption value, the first random value, and the second random value;
a 2-8 step of transmitting, by the repository, a session ID, the third homomorphic encryption valuer, and the fourth homomorphic encryption value, to the user terminal;
a 2-9 step of receiving, by the repository, the session ID, the third identity verification ID, the second validity verification value, and the tag, from the user terminal;
a 2-10 step of verifying, by the repository, the tag by determining whether the value calculated by carrying out the first arithmetic operation to the first random value, the third identity verification ID and the second random value is identical to the tag received in the 2-9 step after the third identity verification ID is verified;
a 2-11 step of generating, by the repository, a sixth validity verification value which is a value calculated by carrying out electronic signature to a fifth value including the fifth validity verification value;
a 2-12 step of transmitting, by the repository, the fourth value, the fifth validity verification value, and the sixth validity verification value, to the user terminal;
a 2-13 step of receiving, by the account module, the first identity verification ID, the second validity verification value, the fourth value, the fifth value, the fifth validity verification value, the sixth validity verification value from the user terminal;
a 2-14 step of verifying, by the account module, the fifth validity verification value and the sixth validity verification value;
a 2-15 step of verifying, by the account module, the first identity verification ID, the second validity verification value and the first hash value; and
a 2-16 step of generating, by the account module, a token, thereafter transmitting the token to the user terminal.

10. The computer-implemented method of claim 9, wherein the fourth value includes a time information of the account module; and the fifth value comprises the fifth validity verification value and the time information of the repository.

11. A computer-implemented method of registering an account module, which is carried out in an environment including a user terminal and the account module, the method comprising:
a first step of receiving, by the account module, a request for registering the account module along with a first homomorphic encryption value which is a value calculated by carrying out homomorphic encryption to a 2-1 random value generated by the user terminal, from the user terminal;
a second step of generating, by the account module, a first identity verification ID;
a third step of storing, by the account module, the first identity verification ID and the first homomorphic encryption value;
a fourth step of generating, by the account module, a second validity verification value which verifies the first identity verification ID;
a fifth step of generating, by the account module, a second identity verification ID;
a sixth step of generating, by the account module, a second homomorphic encryption value which is a value calculated by carrying homomorphic encryption to the second identity verification ID;
a seventh step of generating, by the account module, a third validity verification value which is a value calculated by carrying our electronic signature to a third value including the second identity verification ID and the second homomorphic encryption value; and
an eighth step of transmitting, by the account module, the first identity verification ID, the second validity verification value, the third value, and the third validity verification value to the user terminal,
wherein the first identity verification ID is uniquely assigned to the account module for each user; and the second identity verification ID is calculated by carrying out one-way function to a value including the first identity verification ID.

12. A computer-implemented method of establishing a digital identity by registering the repository after the account module is registered by the method of claim 11, the method comprising:
a 1-1 step of receiving, by the repository, identity verification information, a third value including a second homomorphic encryption value which is a value calculated by carrying out homomorphic encryption to the second identity verification ID, and a third validity verification value which is a value calculated by carrying out electronic signature to the second homomorphic encryption value, from the user terminal;
a 2-1 step of verifying, by the repository, the third validity verification value;
a 3-1 step of querying, by the repository, the identity verification information;
a 4-1 step of generating, by the repository, a third homomorphic encryption value which is a value calculated by carrying out homomorphic encryption to the third identity verification ID;
a 5-1 step of generating, by the repository, a value by carrying out the first arithmetic operation to the first random value, the third homomorphic encryption value and the second random value, as a fourth homomorphic encryption value which is a value calculated by carrying out homomorphic encryption to the tag;
a 6-1 step of transmitting, by the repository, a session ID, the third homomorphic encryption value and the fourth homomorphic encryption value, to the user terminal;
a 7-1 step of receiving, by the repository, the session ID, the third identity verification ID and the tag;
an 8-1 step of storing, by the repository, the third identity verification ID and the identity verification information, if the value calculated by carrying out the first arithmetic operation to the first random value, the third identity verification ID and the second random value is identical to the tag received in the 7-1 step;
a 9-1 step of generating, by the repository, a fourth validity verification value which verifies the third identity verification ID;
a 10-1 step of generating, by the repository, a ninth validity verification value which is a value calculated by carrying out electronic signature to a value including a third value and the third validity verification value;
a 11-1 step of transmitting, by the repository, the fourth verification value and the ninth validity verification value, to the user terminal;
a 12-1 step of receiving, by the account module, a request of registering the repository along with the first identity verification ID, the third value, the third validity verification value and the ninth validity verification value, from the user terminal; and
a 13-1 step of registering, by the account module, the repository if the third validity verification value and the ninth validity verification value are verified,
wherein the third identity verification ID is calculated by carrying out one-way function to a value including the second homomorphic encryption value.

13. A computer-implemented method of establishing a digital identity, which is carried out in an environment including a user terminal, an account module and a repository, the method comprising:
a first step of receiving, by the repository, identity verification information, a third value including a second homomorphic encryption value which is a value calculated by carrying out homomorphic encryption to a second identity verification ID, a third verification value which is a value calculated by carrying out electronic signature to the third value, and an encryption value (Ze) of zero from the user terminal;
a second step of verifying, by the repository, the third validity verification value;
a third step of querying, by the repository, the identity verification information;
a fourth step of generating, by the repository, a third homomorphic encryption value which is a value calculated by carrying out homomorphic encryption to the third identity verification ID;
a fifth step of generating, by the repository, a value which is calculated by carrying out a second arithmetic operation to a first random value (r1), the third homomorphic encryption value, a second random value (r2), a third random value (r3) and Ze, as a fourth homomorphic encryption value which is a value calculated by carrying out homomorphic encryption to a tag;
a sixth step of transmitting, by the repository, a session ID, the third homomorphic encryption value, the fourth homomorphic encryption value, a first constant (G) and a second constant (P), to the user terminal;
a seventh step of receiving, by the repository, the session ID, 1D_3$(=G^{ID_3} (mod P)) and tag$(=G^{tag} (mode P)) from the user terminal; and
an eighth step of storing, by the repository, the third identity verification ID and the identity verification information, if tag$ is identical to ID_3$^{r1}*G^{r2} (mod P),
wherein the first identity verification ID is uniquely assigned to the account module for each user; the second identity verification ID is calculated by carrying out one-way function to a value including the first identity verification ID; and the third identity verification ID is calculated by carrying out one-way function to a value including the second homomorphic encryption value.

14. A computer-implemented method of authenticating an identity after the digital identity is established by the method of claim 1, the method comprising:
a 2-1 step of receiving, by the account module, a first identity verification ID and a second validity verification value;
a 2-2 step of generating, by the account module, a first hash value which is a value calculated by hashing the first identity verification ID and the second validity verification value;
a 2-3 step of generating, by the account module, a second homomorphic encryption value which is a value calculated by carrying out homomorphic encryption to the second identity verification ID;
a 2-4 step of generating, by the account module, a fifth validity verification value which is a value calculated by carrying out electronic signature to a fourth value including the second homomorphic encryption value and the first hash value;
a 2-5 step of transmitting, by the account module, the fourth value and the fifth validity verification value to the user terminal;
a 2-6 step of receiving, by the repository, the third identity verification ID, the fourth validity verification value, the fourth value, the fifth validity verification value and an encryption value (Ze) of zero, from the user terminal;
a 2-7 step of generating, by the repository, a value calculated by carrying out a second arithmetic operation to a first random value (r1), the third homomorphic encryption value, a second random value (r2), a third random value (r3) and Ze, as a fourth homomorphic encryption value which is a value calculated by carrying out homomorphic encryption to the tag;
a 2-8 step of transmitting, by the repository, a session ID, the third homomorphic encryption value, the fourth homomorphic encryption value, a first constant (G) and a second constant (P), to the user terminal;
a 2-9 step of receiving, by the repository, the session ID, 1D_3$(=G^{ID_3} (mod P)) and tag$(=G^{tag} (mod P)), from the user terminal;
a 2-10 step of verifying, by the repository, the tag by determining whether tag$ is identical to ID_3$^{r1}*G^{r2} (mod P);
a 2-11 step of generating, by the repository, the sixth validity verification value by carrying out electronic signature to a fifth value including the fifth validity verification value;
a 2-12 step of transmitting, by the repository, a fourth value, the fifth validity verification value, and the sixth validity verification value, to the user terminal;
a 2-13 step of receiving, by the account module, the first identity verification ID, the second validity verification value, the fourth value, the fifth value, the fifth validity verification value and the sixth validity verification value, from the user terminal;
a 2-14 step of verifying, by the account module, the fifth validity verification value and the sixth validity verification value;
a 2-15 step of verifying, by the account module, the first identity verification ID, the second validity verification value, and the first hash value; and
a 2-16 step of generating a token and transmitting the token to the user terminal, by the account module.

15. A computer-implemented method of establishing a digital identity by registering a repository after an account module is registered according to the method of claim 11, the method comprising:
a 1-1 step of receiving, by the repository, identity verification information, a third value including a second homomorphic encryption value which is calculated by carrying out homomorphic encryption to a second identity verification ID, a third validity verification value which is calculated by carrying out electronic signature to the third value, and an encryption value (Ze) of zero, from the user terminal;
a 2-1 step of verifying, by the repository, the third validity verification value;
a 3-1 step of querying, by the repository, the identity verification information;
a 4-1 step of generating, by the repository, the third homomorphic encryption value which is a value calculated by carrying out homomorphic encryption to the third identity verification ID;
a 5-1 step of generating, by the repository, a value which is calculated by carrying out a second arithmetic operation to a first random value (r1), the third homomorphic encryption value, a second random value (r2) and Ze, as a fourth homomorphic encryption value which is calculated by carrying out homomorphic encryption to a tag;
a 6-1 step of transmitting, by the repository, a session ID, the third homomorphic encryption value, the fourth homomorphic encryption value, a first constant (G) and a second constant (P), to the user terminal;
a 7-1 step of receiving, by the repository, the session ID, 1D_3$(=G^{ID_3} (mod P)) and tag$(=G^{tag} (mod P)), from the user terminal;
an 8-1 step of storing, by the account module, the third identity verification ID and the identity verification information, if tag$ is identical to ID_3$^{r1}*G^{r2} (mod P));
a 9-1 step of generating, by the repository, a fourth validity verification value which verifies the third identity verification ID;
a 10-1 step of generating, by the repository, a ninth validity verification value for the third value and the third validity verification value;
an 11-1 step of transmitting, by the repository, the fourth validity verification value and the ninth validity verification value, to the user terminal;
a 12-1 step of receiving, by the account module, a request for registering the repository along with the first identity verification ID, the third value, the third validity verification value and the ninth validity verification value, from the user terminal; and
a 13-1 step of registering, by the account module, the repository, if the verification of the third validity verification value and the ninth validity verification value is successful,
wherein the third identity verification ID is calculated by carrying out one-way function to a value including the second homomorphic encryption value.
